(19) United States
(12) Patent Application Publication
(10) Pub. No.: US 2023/0313551 A1
(43) Pub. Date: Oct. 5, 2023

(54) AUTOMATIC SWIMMING POOL CLEANER CHARGING SYSTEMS AND DEVICES WITH CORROSION MITIGATION

(71) Applicant: Zodiac Pool Care Europe, Belberaud (FR)

(72) Inventors: Arnaud Lancry, Le Vernet (FR); Louis Favié, Colomiers (FR)

(73) Assignee: Zodiac Pool Care Europe, Belberaud (FR)

(21) Appl. No.: 18/126,101

(22) Filed: Mar. 24, 2023

Related U.S. Application Data
(60) Provisional application No. 63/324,973, filed on Mar. 29, 2022.

(51) Int. Cl. E04H 4/16

(52) U.S. Cl. CPC E04H 4/1654

(57) ABSTRACT

Charging systems and devices for automatic swimming pool cleaners may include one or more electrical contacts with corrosion mitigation features. Such electrical contacts may be on the automatic swimming pool cleaner and/or the charging system. The corrosion mitigation features may include a material of the electrical contacts and/or a surface treatment of the electrical contacts. Charging or recharging of the automatic swimming pool cleaner using the charging systems may be controlled based on a detection of water on the one or more electrical contacts.

### REFERENCE TO RELATED APPLICATION

This application claims the benefit of U.S. Provisional Patent Application No. 63/324,973, filed on Mar. 29, 2022, and entitled AUTOMATIC SWIMMING POOL CLEANER CHARGING SYSTEMS AND DEVICES WITH CORROSION MITIGATION, the content of which is incorporated by reference in its entirety.

### FIELD OF THE INVENTION

The invention relates to automatic swimming pool cleaners (APCs) for cleaning water-containing vessels such as swimming pools and spas and more particularly, although not necessarily exclusively, to charging systems and devices for APCs with corrosion mitigation.

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Certain APCs, such as those with on-board power sources such as on-board batteries, periodically may need to charge or recharge themselves. In such cases, the APC may include electrical contacts, and the APC is placed so that the electrical contacts of the APC contact corresponding electrical contacts of a charging system such as a charging station, charging dock, or charging trolley. Electrical contacts of the APC and the charging system may suffer corrosion due to pool chemistry and pool contents that come in contact with the electrical contacts. For example, the water itself may cause corrosion, as well as contents of the water such as salt, free available chlorine, combined chlorine, acid fluids, basic fluids, substances of varying pH, substances of varying alkalinity, calcium hardness, cyanuric acid, dirt, and/or air. Such contents may exacerbate corrosive effects that can occur when electrical current passes through the electrical contacts, particularly if the electrical contacts are wet. Moreover, temperature, humidity, and other environmental factors can also exacerbate the electrical contacts' propensity to corrode when wet and/or exchanging current. Such corroded electrical contacts can compromise the charging efficiency of an APC, can pose an electrical shock hazard, can compromise the ability of a battery within the APC to hold a charge, and can harm the life of the battery, the trolley, or the APC.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an APC includes an electrical contact with a corrosion-mitigating feature.

According to various embodiments, a charging system for an APC includes an electrical contact with a corrosion-mitigating feature.

According to some embodiments, an electrical contact for an APC or a charging system for the APC includes titanium or an electrically conductive plastic.

According to certain embodiments, an APC includes a charging control system for controlling charging of the APC based on a detection of water on an electrical contact.

According to certain embodiments, swimming pool cleaning system includes an APC and a charging system for the APC, the APC includes a first electrical contact and the charging system includes a second electrical contact, and at least one of the first electrical contact of the second electrical contact includes a corrosion-mitigating feature.

According to various embodiments, a swimming pool cleaning system includes an electrical contact enabling charging of an APC, and the electrical contact includes a corrosion-mitigating feature.

According to various embodiments, a swimming pool cleaning system includes an automatic swimming pool cleaner APC, a charging system for selectively charging or recharging the APC, and a charging control system for controlling charging or recharging of the APC using the charging system based on a detection of water.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an APC and a charging system according to embodiments.

FIG. 2 illustrates electrical contacts of the APC of FIG. 1 according to embodiments.

FIG. 3 illustrates electrical contacts of the charging system of FIG. 1 according to embodiments.

FIG. 4 illustrates electrical contacts of the charging system of FIG. 1 with a surface treatment according to embodiments.

### DETAILED DESCRIPTION

Described herein are charging systems and devices for APCs with corrosion mitigation features. Such features may minimize or prevent corrosion from damaging electrical contacts used for charging of the APC. Additionally, or alternatively, the corrosion mitigation features may create a self-passivation layer on a surface of the electrical contacts for maintaining electric continuity along the electrical contacts without corrosion. In some embodiments, a corrosion mitigation feature according to embodiments may be an electrical contact comprising titanium and/or electrically conductive plastics. While the systems and devices provided herein are discussed in the context of electrical charging, the corrosion mitigation features may be provided on any contacts or surfaces for any charging and/or electrical contact that may come into contact with water.

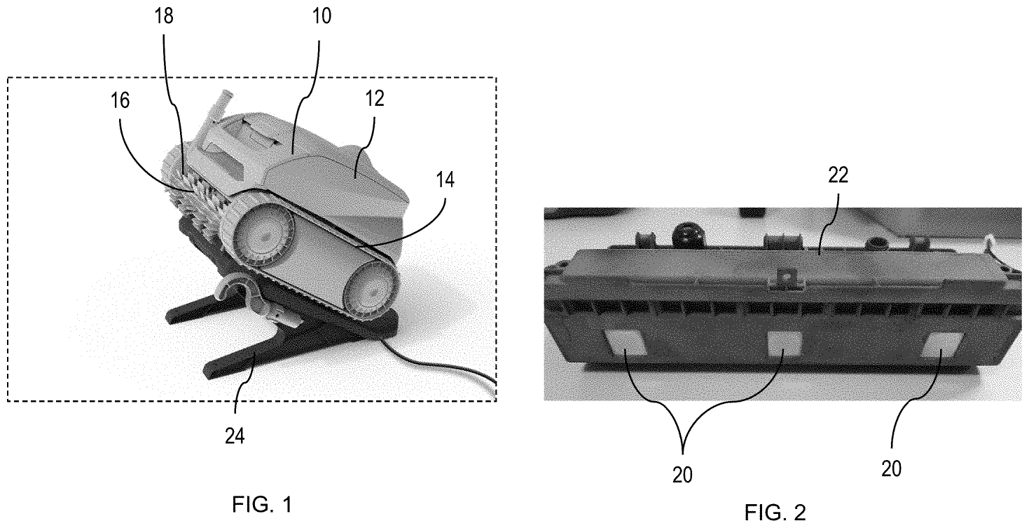

FIGS. 1-3 illustrate an APC 10 and a charging system 24 according to embodiments. The APC 10 generally includes a body 12, one or more motive elements 14, and one or more cleaning devices 16 (including but not limited to a scrubber brush 18). A motor, pump, filter, and various other features may be provided on or within the APC 10 as desired. Non-limiting examples of APCs 10 may include those described in U.S. Pat. Nos. 10,316,534, 9,488,154, 8,578,538, and U.S. Patent Publication No. 2014/0303810, all of which are hereby incorporated by reference in their entireties.

As illustrated in FIG. 2, the APC 10 may include one or more electrical contacts 20. In the example illustrated, the electrical contacts 20 are provided on a battery pack 22 of the APC 10 and are for charging the battery pack 22. However, in other embodiments, the electrical contacts 20 may be provided on various locations of the APC 10 as desired and need not be on a battery pack 22.

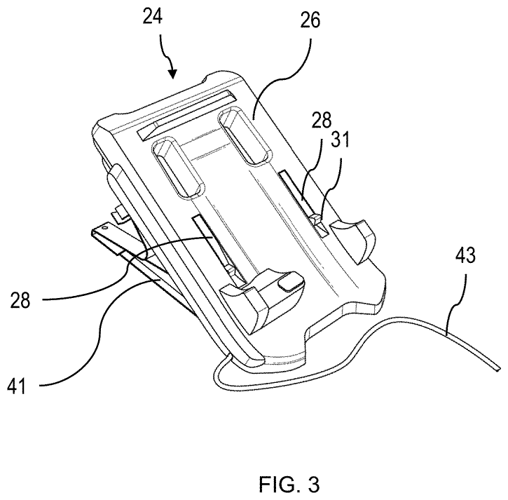

Referring to FIG. 3, the charging system 24 may include a base or dock 26 with electrical contacts 28 for selectively contacting the electrical contacts 20 of the APC 10. The charging system 24 may include a cable 43 or other suitable device for connecting the charging system 24 to a power source; however, in other embodiments, the charging system 24 may include an onboard power source. Stoppers 45 may be provided on the dock 26 and may be used to facilitate positioning of the APC 10 on the charging system 24. As a non-limiting example, the stoppers 45 may facilitate positioning of the APC 10 on the charging system 24 such that the electrical contacts 20 of the APC 10 are properly positioned relative to the electrical contacts 28 for charging.

In the example illustrated, the electrical contacts 28 are elongated and include raised portions 31 for facilitating contact with the electrical contacts 20 of the APC 10. In certain examples, the electrical contacts 28 may be flexible and/or springs that are movable relative to the dock 26. In various embodiments, the spring-loaded or otherwise biased electrical contacts 28 may increase contact pressure between charging contacts 20, 28, and increasing contact pressure may reduce electrolysis between the contacts 20, 28. However, the particular shape, size, number, and location of the electrical contacts 20, 28 should not be considered limiting. The electrical contacts may be of any suitable geometry. Other non-limiting example geometries include, but are not limited to, flat or raised plates meeting between the APC 10 and the charging system 24, male and female pins and sockets of any number, or clips and terminals, combinations thereof, and/or other profiles or shapes as desired. In some embodiments, the thickness of the flexible electrical contacts 20, 28 may be controlled to control the contact pressure between contacting electrical contacts 20, 28. As a non-limiting example, the thickness of the flexible electrical contacts 20, 28 may be increased to increase a contact pressure.

Moreover, while the charging system 24 is illustrated as a docking station, in other embodiments, the charging system 24 may be a trolley (e.g., including motive elements such as wheels rather than feet 41), other charging station, garage, and/or other structures and/or devices with electrical contacts 28 and suitable for selectively charging the APC 10. As such, the particular charging system 24 illustrated should not be considered limiting.

In certain embodiments, a corrosion mitigation feature may be included with the electrical contacts 20 and/or the electrical contacts 28. In some embodiments, a corrosion mitigation feature may include a material used to construct and/or coat the electrical contacts 20, 28. As a non-limiting example, the electrical contacts 20, 28 may be constructed from a corrosion-mitigating material, such as but not limited to titanium, brass, electrically conductive plastics, combinations thereof, and/or various other corrosion-mitigating materials as desired. As another non-limiting example, the electrical contacts 20, 28 may be coated with a corrosion-mitigating material, such as but not limited to titanium, brass, electrically conductive plastics, combinations thereof, and/or various other corrosion-mitigating materials as desired. As a non-limiting example, the electrical contacts 20, 28 may be constructed from any grade of titanium as desired. As another non-limiting example, the electrical contacts 20, 28 may be constructed from an electrically conductive plastic such as but not limited to conductive polyoxymethylene, conductive polyetheretherketone, conductive polyvinylidene fluoride, combinations thereof, and/or other suitable electrically conductive plastics as desired.

Optionally, the electrical contacts 20, 28 may include a combination of materials such that the electrical contacts 20, 28 promote electric conductivity while minimizing or preventing corrosion. As one example, an electrical contact may include titanium (or other suitable materials) embedded in plastic to make it conductive. As a further embodiment, an electrical contact may include corrosion-mitigating materials as a surface coating or layer on another material. Non-limiting examples of such embodiments may include a coating of titanium and/or an electrically charged plastic on a base material (such as but not limited to stainless steel).

In some embodiments, at least one or more specific electrical contacts 20, 28 and/or portions of such contacts may include a corrosion-mitigating material. As a non-limiting example, at least a positive side of an electrical contact may include titanium. Additionally, or alternatively, and as previously mentioned, the corrosion-mitigating material may be provided as a surface coating or layer on a base material of electrical contacts 20, 28.

Optionally, the electrical contacts 20, 28 may include a surface treatment for mitigating corrosion, alone or in combination with the corrosion-mitigating material. Such surface treatments may mitigate corrosion by increasing local pressure, locally reduce an amount of water, and/or otherwise reduce electrolysis and mitigate corrosion. Surface treatments may include, but are not limited to, surface geometry, surface features, surface structures, surface textures, a drying treatment, nitrate, passivation, nitruration, and/or ruthenium, combinations thereof, and/or other surface treatments as desired.

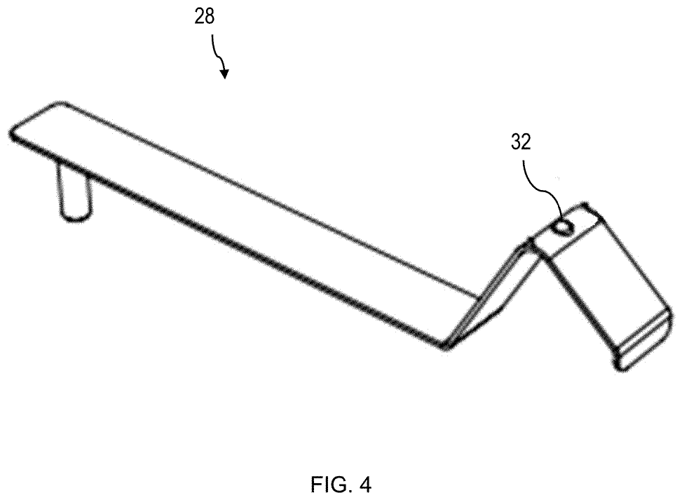

As a non-limiting example, FIG. 4 illustrates the electrical contact 28 with a raised portion or boss 42 as the surface treatment. In this example, the boss 42 may locally reduce the contact surface between the electrical contacts 20, 28. Additionally, or alternatively, the boss 42 may increase the contact pressure between charging electrical contacts 20, 28. Reducing the contact surface between the charging electrical contacts 20, 28 and/or increasing the contact pressure between the charging electrical contacts 20, 28 reduces electrolysis between the electrical contacts 20, 28, thereby reducing corrosion. In various embodiments, the boss 42 as the surface treatment may further allow for water to drain between the electrical contacts 20, 28 and may locally reduce the amount of water between the electrical contacts 20, 28 (e.g., due to the reduced contact between the electrical contacts 20, 28). The drainage of water and reduced amount of water between the electrical contacts 20, 28 due to the boss 42 as the surface treatment may further reduce electrolysis between the electrical contacts 20, 28. In some embodiments, of a pair of charging, contacting electrical contacts 20, 28, one electrical contact or both electrical contacts may include the boss 42 or other surface treatment as desired. The particular shape of the boss 42 should not be considered limiting.

As another non-limiting example of a surface treatment, the charging system 24 and/or the APC 10 may include a drying treatment for reducing the amount of water on the electrical contacts 20, 28 and thereby reducing electrolysis. Drying treatments as surface treatments may include, but are not limited to, as blowing or directing air locally on the electrical contacts 20, 28, wiping the electrical contacts 20, 28 with a drying device, and/or vibrating or shaking the electrical contacts 20, 28.

In certain embodiments, the APC 10 and/or the charging system 24 optionally may include a charging control system for controlling charging of the APC 10. Such a charging control system may include a control device (e.g., processor and/or memory) and/or other suitable devices and/or systems for controlling charging of the APC 10. As a non-limiting example, the charging control system may be a control device onboard the APC 10 and/or a control device remote from the APC 10 but configured to control charging (e.g., by controlling the power source, etc.). When the charging control system is included, the charging control system may control charging to minimize corrosion and/or to improve safety during charging.

As one non-limiting example, the charging control system may control charging by only beginning a charging cycle and/or continuing charging when the electrical contacts 28 and/or the electrical contacts 20 are determined to be dry. Such a determination may be made using various techniques and/or devices as desired, including but not limited to one or more sensors on the APC 10 and/or the charging system 24 for detecting a presence (or absence) of liquid. As a non-limiting example, the APC 10 may detect if the electrical contacts 20 are wet, and if so, stop a charging cycle and/or not start a charging cycle until the electrical contacts are dry. In such embodiments, the APC 10 may wait until the electrical contacts 28 and/or 20 are dry to start charging and/or resume charging.

As mentioned, the APC 10 and/or the charging system 24 may detect a presence of moisture and know whether the contacts are wet using various techniques as desired. In one non-limiting example, the APC 10 may determine the presence of water by measuring a resistance between two electrical contacts 20. In another non-limiting example, the APC 10 may wait until a specified time or for a specified duration (e.g., 30 minutes) after detecting the contacts are wet before re-checking whether the electrical contacts 20 are wet and to start/continue charging. In some embodiments, the charging control system optionally may require a dry detection of the electrical contacts before proceeding with and/or maintaining a charging cycle. The aforementioned control of charging is for illustrative purposes, and in other embodiments, the charging control system may provide other control of charging of the APC 10.

In certain embodiments, the electrical contacts with corrosion-mitigating features may allow for the exchange of alternating current, direct current, or a combination of alternating and direct current. The electrical contacts may exchange current by either electrical connection, induction, capacitive coupling, or any other suitable means of exchanging energy. In addition to preventing corrosion that may occur during the charging process, electrical contacts provided herein may also be resistant to scratches, may possess a pleasing aesthetic, and may alleviate anxiety of an end user.

Exemplary concepts or combinations of features of the invention may include:
A. An APC comprising an electrical contact with a corrosion-mitigating feature.
B. The APC of any preceding or subsequent statement or combination of statements, wherein the corrosion-mitigating feature comprises a material of the electrical contact.
C. The APC of any preceding or subsequent statement or combination of statements, wherein the electrical contact comprises titanium or an electrically conductive plastic.
D. The APC of any preceding or subsequent statement or combination of statements, wherein the corrosion-mitigating feature comprises a surface treatment on the electrical contact.
E. The APC of any preceding or subsequent statement or combination of statements, wherein the corrosion-mitigating feature comprises a surface treatment comprising surface geometry, surface features, surface structures, surface textures, a drying treatment, nitrate, passivation, nitruration, and/or ruthenium, among others.
F. The swimming pool cleaning system of any preceding or subsequent statement or combination of statements, wherein the surface treatment comprises a boss on at least one of the first electrical contact or the second electrical contact.
G. The swimming pool cleaning system of any preceding or subsequent statement or combination of statements, wherein the surface treatment is configured to increase a contact pressure between the first electrical contact and the second electrical contact.
H. The swimming pool cleaning system of any preceding or subsequent statement or combination of statements, wherein the surface treatment is configured to reduce an amount of water between the first electrical contact and the second electrical contact.
I. A charging system for an APC comprising an electrical contact with a corrosion-mitigating feature.
J. An electrical contact for an APC or a charging system for the APC, the electrical contact comprising titanium or an electrically conductive plastic.
K. An APC comprising a charging control system for controlling charging of the APC based on a detection of water on an electrical contact.
L. The APC of any preceding or subsequent statement or combination of statements, wherein the charging control system is configured to stop a charging cycle or not start a charging cycle based on a detection of the presence of water.
M. The APC of any preceding or subsequent statement or combination of statements, wherein the charging control system is configured to detect water based on resistance between two electrical contacts.
N. The APC of any preceding or subsequent statement or combination of statements, wherein the charging control system is configured to wait a predetermined time after an initial detection of water before starting or resuming charging.
O. The APC of any preceding or subsequent statement or combination of statements, wherein the charging control system is configured to only begin a charging cycle based on a detection of the absence of water.
P. A swimming pool cleaning system comprising an APC and a charging system for the APC, wherein the APC comprises a first electrical contact and the charging system comprises a second electrical contact, and wherein at least one of the first electrical contact of the second electrical contact comprises a corrosion-mitigating feature.
Q. The swimming pool cleaning system of any preceding or subsequent statement or combination of statements, wherein both the first electrical contact and the second electrical contact comprise the corrosion-mitigating feature.
R. The swimming pool cleaning system of any preceding or subsequent statement or combination of statements, wherein the corrosion-mitigating feature comprises a material of the electrical contact.
S. The swimming pool cleaning system of any preceding or subsequent statement or combination of statements, wherein the material comprises at least one of titanium or an electrically conductive plastic.
T. The swimming pool cleaning system of any preceding or subsequent statement or combination of statements, wherein the corrosion-mitigating feature comprises a surface treatment.
U. The swimming pool cleaning system of any preceding or subsequent statement or combination of statements, wherein the surface treatment comprises surface geometry, surface features, surface structures, surface textures, a drying treatment, nitrate, passivation, nitruration, and/or ruthenium, among others
V. The swimming pool cleaning system of any preceding or subsequent statement or combination of statements, further comprising a charging control system for controlling a charging of the APC using the charging system.
W. The swimming pool cleaning system of any of any preceding or subsequent statement or combination of statements, wherein the charging control system is configured to control charging of the APC based on a detection of water on the first electrical contact or the second electrical contact.
X. The swimming pool cleaning system of any preceding or subsequent statement or combination of statements, wherein the charging control system is configured to stop a charging cycle or prevent initiation of a charging cycle based on a detected presence of water.
Y. A swimming pool cleaning system comprising an electrical contact enabling charging of an APC, wherein the electrical contact comprises a corrosion-mitigating feature.
Z. The swimming pool cleaning system of any preceding or subsequent statement or combination of statements, wherein the electrical contact is on the APC.
AA. The swimming pool cleaning system of any preceding or subsequent statement or combination of statements, wherein the electrical contact is on a charging system for the APC.
BB. The swimming pool cleaning system of any preceding or subsequent statement or combination of statements, wherein the corrosion-mitigating feature comprises a material of the electrical contact, and wherein the material comprises at least one of titanium or an electrically conductive plastic.
CC. The swimming pool cleaning system of any preceding or subsequent statement or combination of statements, wherein the corrosion-mitigating feature comprises a surface treatment on the electrical contact, and wherein the surface treatment comprises surface geometry, surface features, surface structures, surface textures, a drying treatment, nitrate, passivation, nitruration, and/or ruthenium, among others.
DD. A swimming pool cleaning system comprising an APC, a charging system for selectively charging or recharging the APC, and a charging control system for controlling charging or recharging of the APC using the charging system based on a detection of water.
EE. The swimming pool cleaning system of any preceding or subsequent statement or combination of statements, wherein the charging control system is configured to control charging of the APC based on the detection of water on an electrical contact of the APC or the charging system.
FF. The swimming pool cleaning system of any preceding or subsequent statement or combination of statements, wherein the charging control system is configured to stop a charging cycle or prevent initiation of a charging cycle based on a detected presence of water on the electrical contact.
GG. The swimming pool cleaning system of any preceding or subsequent statement or combination of statements, wherein the charging control system is configured to wait a duration of time after an initial detection of water before starting or resuming charging.
HH. The swimming pool cleaning system of any preceding or subsequent statement or combination of statements, wherein the charging control system is configured to only begin a charging cycle based on an absence of water on the electrical contact.
II. The swimming pool cleaning system of any preceding or subsequent statement or combination of statements, wherein the charging control system is configured to detect water based on resistance between two electrical contacts.
JJ. A swimming pool cleaning system comprising an electrical contact enabling charging of an APC with a charging system, wherein the electrical contact comprises a corrosion-mitigating feature, and wherein the corrosion-mitigating feature comprises a surface treatment.
KK. The swimming pool cleaning system of any preceding or subsequent statement or combination of statements, wherein the corrosion-mitigating feature comprises a material of the electrical contact, and wherein the material comprises at least one of titanium or an electrically conductive plastic.
LL. The swimming pool cleaning system of any preceding or subsequent statement or combination of statements, wherein the surface treatment comprises a boss on the electrical contact.
MM. The swimming pool cleaning system of any preceding or subsequent statement or combination of statements, wherein the surface treatment is configured to reduce a contact surface in order to increase local pressure with another electrical contact during charging.
NN. The swimming pool cleaning system of any preceding or subsequent statement or combination of statements, wherein the surface treatment is configured to increase a contact pressure with another electrical contact during charging.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A swimming pool cleaning system comprising an automatic swimming pool cleaner (APC) and a charging system for the APC, wherein the APC comprises a first electrical contact and the charging system comprises a second electrical contact, and wherein at least one of the first electrical contact of the second electrical contact comprises a corrosion-mitigating feature.

2. The swimming pool cleaning system of claim 1, wherein both the first electrical contact and the second electrical contact comprise the corrosion-mitigating feature.

3. The swimming pool cleaning system of claim 1, wherein the corrosion-mitigating feature comprises a material of the electrical contact.

4. The swimming pool cleaning system of claim 3, wherein the material comprises at least one of titanium or an electrically conductive plastic.

5. The swimming pool cleaning system of claim 1, wherein the corrosion-mitigating feature comprises a surface treatment.

6. The swimming pool cleaning system of claim 5, wherein the surface treatment comprises surface geometry, surface features, surface structures, surface textures, a drying treatment, nitrate, passivation, nitruration, and/or ruthenium.

7. The swimming pool cleaning system of claim 5, wherein the surface treatment comprises a boss on at least one of the first electrical contact or the second electrical contact.

8. The swimming pool cleaning system of claim 5, wherein the surface treatment is configured to increase a contact pressure between the first electrical contact and the second electrical contact.

9. The swimming pool cleaning system of claim 5, wherein the surface treatment is configured to reduce an amount of water between the first electrical contact and the second electrical contact.

10. The swimming pool cleaning system of claim 1, further comprising a charging control system for controlling a charging of the APC using the charging system, wherein the charging control system is configured to control charging of the APC based on a detection of water on the first electrical contact or the second electrical contact.

11. The swimming pool cleaning system of claim 8, wherein the charging control system is configured to stop a charging cycle or prevent initiation of a charging cycle based on a detected presence of water.

12. A swimming pool cleaning system comprising an electrical contact enabling charging of an automatic swimming pool cleaner (APC) with a charging system, wherein the electrical contact comprises a corrosion-mitigating feature, and wherein the corrosion-mitigating feature comprises a surface treatment.

13. The swimming pool cleaning system of claim 12, wherein the corrosion-mitigating feature comprises a material of the electrical contact, and wherein the material comprises at least one of titanium or an electrically conductive plastic.

14. The swimming pool cleaning system of claim 12, wherein the surface treatment comprises a boss on the electrical contact.

15. The swimming pool cleaning system of claim 12, wherein the surface treatment is configured to reduce a contact surface in order to increase local pressure with another electrical contact during charging.

16. The swimming pool cleaning system of claim 12, wherein the surface treatment is configured to increase a contact pressure with another electrical contact during charging.

17. A swimming pool cleaning system comprising an automatic swimming pool cleaner (APC), a charging system for selectively charging or recharging the APC, and a charging control system for controlling charging or recharging of the APC using the charging system based on a detection of water.

18. The swimming pool cleaning system of claim 17, wherein the charging control system is configured to control charging of the APC based on the detection of water on an electrical contact of the APC or the charging system.

19. The swimming pool cleaning system of claim 16, wherein the charging control system is configured to perform at least one of:
stopping a charging cycle or prevent initiation of a charging cycle based on a detected presence of water on the electrical contact;
waiting a duration of time after an initial detection of water before starting or resuming charging; or
only begin a charging cycle based on an absence of water on the electrical contact.

20. The swimming pool cleaning system of claim 17, wherein the charging control system is configured to detect water based on resistance between two electrical contacts.
